(19) United States
(12) Patent Application Publication
(10) Pub. No.: US 2025/0138380 A1
(43) Pub. Date: May 1, 2025

(54) COLOR ELECTRO-OPTIC DISPLAY COMPRISING A LIGHT FASTNESS ADDITIVE

(71) Applicant: E INK CORPORATION, Billerica, MA (US)

(72) Inventors: Stephen J. TELFER, Arlington, MA (US); Rosa CASADO, Middleton, MA (US); Sergey EGOROV, Nashua, NH (US); Ana L. LATTES, Newton, MA (US)

(21) Appl. No.: 18/924,360

(22) Filed: Oct. 23, 2024

Related U.S. Application Data
(60) Provisional application No. 63/546,536, filed on Oct. 31, 2023.

(51) Int. Cl. G02F 1/167; G02F 1/16757; G02F 1/1676

(52) U.S. Cl. CPC G02F 1/167; G02F 1/16757; G02F 1/1676

(57) ABSTRACT

A color electro-optic display is disclosed that comprises an electrophoretic medium including charged pigment particles, a light fastness additive, and a non-polar solvent, an organic electroactive compound, and a non-polar liquid. The light fastness additive is an electron acceptor and it improves the light fastness of the color electrophoretic display.

### RELATED APPLICATIONS

This application claims priority to U.S. Provisional Patent Application No. 63/546,536 filed on Oct. 31, 2023, which is incorporated by reference in its entirety, along with all other patents and patent applications disclosed herein.

### BACKGROUND OF THE INVENTION

This invention relates to a color electro-optic display comprising an electro-optic material layer, the electro-optic material layer having an electrophoretic medium comprising a light fastness additive. The light fastness additive improves the light fastness of the color electro-optic display. The electrophoretic medium of the electro-optic material layer of the electro-optic display further comprises charged particles in a non-polar liquid.

The terms “bistable” and “bistability” are used herein in their conventional meaning in the art to refer to displays comprising display elements having first and second display forms differing in at least one optical property, and such that after any given element has been driven, by means of an addressing pulse of finite duration, to assume either its first or second display form, after the addressing pulse has terminated, that state will persist for at least several times, for example at least four times, the minimum duration of the addressing pulse required to change the state of the display element. It is shown in U.S. Pat. No. 7,170,670 that some particle based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electrophoretic media are solid in the sense that the materials have solid external surfaces, although the media may, and often do, have internal liquid filled or gas filled spaces. Displays using solid electrophoretic media may hereinafter be referred to as “solid electrophoretic displays” for convenience.

Several types of electro-optic displays are known. One type of electro-optic display is a rotating bichromal member type as described, for example, in U.S. Pat. Nos. 5,808,783; 5,777,782; 5,760,761; 6,054,071; 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a liquid under the influence of an electric field. Electrophoretic displays can have attributes of good brightness and contrast, wide viewing angles, state bistability, and low power consumption when compared with liquid crystal displays. Nevertheless, problems with the long term image quality of these displays have prevented their widespread usage. For example, particles that make up electrophoretic displays tend to settle, resulting in inadequate service life for these displays.

Typical electrophoretic media of electrophoretic displays comprise at least one charge control agents (CCA). The CCA controls the charge on the electrophoretic particles. Typically, the CCA is a surfactant-like molecule having an ionic or other polar group, hereinafter referred to as head groups, and a non-polar chain (typically a hydrocarbon chain) that is hereinafter referred to as the tail. The CCAs may be complexed with the charged particles or adsorbed onto the particles. It is thought that the CCA forms reverse micelles in the electrophoretic medium and that it is a small population of charged reverse micelles that leads to electrical conductivity in the medium. Reverse micelles comprise a polar core that may vary in size from 1 nm to tens of nanometers, and may have spherical, cylindrical, or other geometry, surrounded by the non-polar tail groups of the CCA molecule. In electrophoretic media, three phases may typically be distinguished: a solid particle having a surface, a highly polar phase that is distributed in the form of extremely small droplets (reverse micelles), and a continuous phase that comprises the non-polar fluid. Both the electrophoretic particles and the charged reverse micelles may move through the fluid upon application of an electric field, and thus there are two parallel pathways for electrical conduction through the fluid (which typically has a vanishingly small electrical conductivity itself).

Numerous patents and applications assigned to or in the names of the Massachusetts Institute of Technology (MIT) and E Ink Corporation describe various technologies used in encapsulated electrophoretic and other electrophoretic media. Such encapsulated media comprise numerous microcapsules, each of which itself comprises an internal phase containing electrophoretically mobile particles in a liquid, and a capsule wall surrounding the internal phase. Typically, the microcapsules are themselves held within a polymeric binder to form a coherent layer positioned between two electrodes. The technologies described in the these patents and applications include:
(a) Electrophoretic particles, fluids and fluid additives; see for example U.S. Pat. Nos. 7,002,728 and 7,679,814;
(b) Microcapsules, binders and encapsulation processes; see for example U.S. Pat. Nos. 6,922,276 and 7,411,719;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. D485,294; 6,124,851; 6,130,773; 6,177,921; 6,232,950; 6,252,564; 6,312,304; 6,312,971; 6,376,828; 6,392,786; 6,413,790; 6,422,687; 6,445,374; 6,480,182; 6,498,114; 6,506,438; 6,518,949; 6,521,489; 6,535,197; 6,545,291; 6,639,578; 6,657,772; 6,664,944; 6,680,725; 6,683,333; 6,724,519; 6,750,473; 6,816,147; 6,819,471; 6,825,068; 6,831,769; 6,842,167; 6,842,279; 6,842,657; 6,865,010; 6,967,640; 6,980,196; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,280,094; 7,327,511; 7,349,148; 7,352,353; 7,365,394; 7,365,733; 7,382,363; 7,388,572; 7,442,587; 7,492,497; 7,535,624; 7,551,346; 7,554,712; 7,583,427; 7,598,173; 7,605,799; 7,636,191; 7,649,674; 7,667,886; 7,672,040; 7,688,497; 7,733,335; 7,785,988; 7,843,626; 7,859,637; 7,893,435; 7,898,717; 7,957,053; 7,986,450; 8,009,344; 8,027,081; 8,049,947; 8,077,141; 8,089,453; 8,208,193; 8,373,211; 9,726,957; 10,520,786; 10,585,325; and 11,513,414; and U.S. Patent Applications Publication Nos. 2002/0060321; 2004/0105036; 2005/0122306; 2005/0122563; 2007/0052757; 2007/0097489; 2007/0109219; 2007/0211002; 2009/0122389; 2009/0315044; 2010/0265239; 2011/0026101; 2011/0140744; 2011/0187683; 2011/0187689; 2011/0286082; 2011/0286086; 2011/0292319; 2011/0292493; 2011/0292494; 2011/0297309; 2011/0310459; and 2012/0182599; and International Application Publication No. WO 00/38000; European Patents Nos. 1,099,207 B1 and 1,145,072 B1;
(e) Color formation and color adjustment; see for example U.S. Pat. No. 7,075,502 and U.S. Patent Application Publication No. 2007/0109219;
(f) Methods for driving displays; see for example U.S. Pat. Nos. 7,012,600; 7,119,772; 7,453,445; and 10,475,396;
(g) Applications of displays; see for example U.S. Pat. Nos. 7,312,784 and 8,009,348; and
(h) Non-electrophoretic displays, as described in U.S. Pat. Nos. 6,241,921; 6,950,220; 7,420,549; and 8,319,759; and U.S. Patent Application Publication No. 2012/0293858.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic medium and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electrophoretic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic displays and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

An electro-optic display normally comprises an electro-optic material layer and at least two other layers disposed on opposed sides of the electro-optic material layer, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic material layer comprises an electrode, the layer on the opposed side of the electro-optic material layer typically being a protective layer intended to prevent the movable electrode damaging the electro-optic material layer.

The manufacture of a three-layer electro-optic display normally involves at least one lamination operation. For example, in several of the aforementioned MIT and E Ink patents and applications, there is described a process for manufacturing an encapsulated electrophoretic display in which an encapsulated electrophoretic medium comprising microcapsules in a binder is coated on to a flexible substrate comprising indium-tin-oxide (ITO) or a similar conductive coating (which acts as one electrode of the final display) on a plastic film, the microcapsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

As discussed in the aforementioned U.S. Pat. No. 6,982,178, (see column 3, lines 63 to column 5, line 46) many of the components used in solid electro-optic displays, and the methods used to manufacture such displays, are derived from technology used in liquid crystal displays (LCD's), which are of course also electro-optic displays, though using a liquid rather than a solid medium. For example, solid electro-optic displays may make use of an active matrix backplane comprising an array of transistors or diodes and a corresponding array of pixel electrodes, and a “continuous” front electrode (in the sense of an electrode which extends over multiple pixels and typically the whole display) on a transparent substrate, these components being essentially the same as in LCD's. However, the methods used for assembling LCD's cannot be used with solid electro-optic displays. LCD's are normally assembled by forming the backplane and front electrode on separate glass substrates, then adhesively securing these components together leaving a small aperture between them, placing the resultant assembly under vacuum, and immersing the assembly in a bath of the liquid crystal, so that the liquid crystal flows through the aperture between the backplane and the front electrode. Finally, with the liquid crystal in place, the aperture is sealed to provide the final display.

This LCD assembly process cannot readily be transferred to solid electro-optic displays. Because the electro-optic material layer is solid, it must be present between the backplane and the front electrode before these two integers are secured to each other. Furthermore, in contrast to a liquid crystal material, which is simply placed between the front electrode and the backplane without being attached to either, a solid electro-optic material layer normally needs to be secured to both; in most cases the solid electro-optic material layer is formed on the front electrode, since this is generally easier than forming the medium on the circuitry-containing backplane, and the front electrode/electro-optic material layer combination is then laminated to the backplane, typically by covering the entire surface of the electro-optic material layer with an adhesive and laminating under heat, pressure and possibly vacuum. Accordingly, most prior art methods for final lamination of solid electrophoretic displays are essentially batch methods in which (typically) the electro-optic material layer, a lamination adhesive and a backplane are brought together immediately prior to final assembly, and it is desirable to provide methods better adapted for mass production.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light transmissive electrically conductive layer; an electro-optic material layer in electrical contact with the electrically conductive layer; an adhesive layer; and a release sheet. Typically, the light transmissive electrically conductive layer will be carried on a light transmissive substrate, which is preferably flexible, in the sense that the substrate can be manually wrapped around a drum (say) 10 inches (254 mm) in diameter without permanent deformation. The term “light transmissive” is used in this patent and herein to mean that the layer thus designated transmits sufficient light to enable an observer, looking through that layer, to observe the change in display states of the electrophoretic medium, which will normally be viewed through the electrically conductive layer and adjacent substrate (if present); in cases where the electrophoretic medium displays a change in reflectivity at non-visible wavelengths, the term “light transmissive” should of course be interpreted to refer to transmission of the relevant non-visible wavelengths. The substrate will typically be a polymeric film and will normally have a thickness in the range of about 1 to about 25 mil (25 to 634 μm), preferably about 2 to about 10 mil (51 to 254 μm). The electrically conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electrophoretic medium and electrically conductive layer to the backplane. This process is well adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a solid electro-optic material layer sandwiched between two adhesive layers, one or both of the adhesive layers being covered by a release sheet. Another form of the double release sheet comprises a solid electro-optic material layer sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light transmissive protective layer and a light transmissive electrically conductive layer; an adhesive layer; a solid electro-optic material layer; and a release sheet. This inverted front plane laminate is used to form an electro-optic display having a layer of lamination adhesive between the electro-optic material layer and the front electrode or front substrate; a second, typically thin, layer of adhesive may or may not be present between the electro-optic material layer and a backplane. Such electro-optic displays can combine good resolution with good low temperature performance.

In a high resolution display, each individual pixel must be addressable without interference from the addressing of adjacent pixels (whether or not the electrophoretic medium used is bistable). One way to achieve this objective is to provide an array of non-linear elements, such as transistors or diodes, wherein at least one non-linear element is associated with each pixel, to produce an active matrix display, as mentioned above. An addressing (pixel) electrode, which addresses one pixel, is connected to an appropriate voltage source through its associated non-linear element. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; the assignment of sources to rows and gates to columns is conventional and could be reversed if desired. The row electrodes are connected to a row driver, which essentially ensures that at any given moment only one row is selected, i.e., that there is applied to the selected row electrode a voltage such as to ensure that all the transistors in the selected row are conductive, while there is applied to all other rows a voltage such as to ensure that all the transistors in these non-selected rows remain non-conductive. The column electrodes are connected to column drivers, which place upon the various column electrodes voltages selected to drive the pixels in the selected row to their desired optical states. The aforementioned voltages are relative to a common front electrode, which is conventionally provided on the opposed side of the electrophoretic medium from the non-linear array and extends across the whole display. After a pre-selected interval known as the “line address time” the selected row is deselected, the next row is selected, and the voltages on the column drivers are changed so that the next line of the display is written. This process is repeated so that the entire display is written in a row-by-row manner.

In the discussion below, the term “waveform” will be used to denote the entire voltage against time curve used to effect the transition of a pixel from one specific initial gray level to a specific final gray level. Typically, such a waveform will comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.”

The electro-optic displays that comprises electrophoretic media having black and white particles are well known in the art and are used for e-readers, e-notes, and other devices for more than a decade. Typically, the black and white particles comprise inorganic pigments. More recently, electro-optic displays that comprises electrophoretic media having color particles, such as yellow, red, and other color particles have been introduced into the market. Typically, such electro-optic displays comprise, in addition to white and, optionally, black particles, color particle that comprise organic pigments. Organic pigments are preferred to inorganic pigments for color displays because they provide brighter color and significantly higher chroma than inorganic pigments. However, typically, organic pigments exhibit lower long term color stability than inorganic pigments in the presence of ultraviolet light and visible light. Thus, there is a need to develop color electro-optic displays comprising electrophoretic media including organic pigments, wherein the color quality of the electro-optic display images is stable even after a long use of the display. The inventors of the present invention surprisingly found that color electro-optic devices comprising electrophoretic media including organic pigments and an electron acceptor molecule significantly improved the long term color quality of the electro-optic display images.

### SUMMARY OF THE INVENTION

Accordingly, the present invention provides a color electro-optic display comprising, in order, a first electrode layer, an electro-optic material layer, and a second electrode layer. The first electrode layer comprises a light transmissive electrode. The second electrode layer comprises a plurality of pixel electrodes. The electro-optic material layer comprises an electrophoretic medium, which is encapsulated in a plurality of microcells or in a plurality of microcapsules. The electrophoretic medium comprises a plurality of first type of charged pigment particles, a plurality of second type of charge pigment particles, a light fastness additive, and a non-polar liquid. At least one of the first and second type of charged pigment particles comprises an organic pigment. The light fastness additive is present in the electrophoretic medium in a content of from 0.1 weight percent to 6.0 weight present by weight of the electrophoretic medium.

The electro-optic material layer may comprise the plurality of microcapsules and a binder, each microcapsule comprising electrophoretic medium. The color electro-optic display, which comprises electrophoretic medium encapsulated in the plurality of microcapsules, may further comprise a first adhesive layer, the first adhesive layer being disposed between the electro-optic material layer and the second electrode layer. The color electrophoretic display that comprises electrophoretic medium encapsulated in the plurality of microcapsules may further comprise, in addition to the first adhesive layer, a second adhesive layer disposed between the electro-optic material layer and the first electrode layer.

The electro-optic material layer may comprise the plurality of microcells. Each microcell of the plurality of microcells may have a microcell bottom, partition walls, an opening, and a sealing layer spanning the opening. The sealing layer may be adjacent to the second electrode layer. Each microcell is filled with electrophoretic medium. The color electro-optic display having a plurality of microcells in the electro-optic material layer may further comprise an adhesive layer, the adhesive layer being disposed between the sealing layer and the second electrode layer.

The electrophoretic medium of the inventive color electro-optic display may comprise, in addition to the plurality of first and second types of charged pigment particles, a plurality of third type of charged pigment particles. The first, second, and third types of pigment particles may have different colors selected from the group consisting of white, black, cyan, magenta, yellow, blue, green, and red. The first, second, and third types of pigment particles may be (a) white, (b) black, and (c) yellow or red, respectively.

The electrophoretic medium of the inventive color electro-optic display may further comprise, in addition to the plurality of first, second and third types of charged pigment particles, a plurality of fourth type of charged pigment particles. The first, second, third, and fourth types of pigment particles may have different colors selected from the group consisting of white, black, cyan, magenta, yellow, blue, green, and red. The first, second, third, and fourth types of pigment particles may be white, cyan, magenta, and yellow respectively. The first, second, third, and fourth types of pigment particles may be white, blue, red, and green, respectively.

The electrophoretic medium of the inventive color electro-optic display may further comprise, in addition to the plurality of first, second, third, and fourth types of charged pigment particles, a plurality of a fifth type of charged pigment particles. The first, second, third, fourth, and fifth types of pigment particles may have different colors selected from the group consisting of white, black, cyan, magenta, yellow, blue, green, and red. The first, second, third, fourth, and fifth types of pigment particles may be white, black, red, blue, and green respectively.

The light fastness additive of the electrophoretic medium of the inventive color electro-optic display improves the light fastness of the display. The light fastness additive is an electron acceptor. The light fastness additive may be selected from the group consisting of a substituted 1,2-benzoquinone, a substituted 1,4-benzoquinone, a substituted naphthoquinone, and a substituted anthraquinone. The substituted 1,2-benzoquinone, the substituted 1,4-benzoquinone, the substituted naphthoquinone, and the substituted anthraquinone may have at least one substituent comprising an alkyl group, a cycloalkyl group, or an alkenyl group. The at least one substituent may have 10 or more carbon atoms. The at least one substituent may have from 10 to 120 carbon atoms.

The substituted 1,2-benzoquinone, the substituted 1,4-benzoquinone, the substituted naphthoquinone, and the substituted anthraquinone may have at least one substituent, the at least one substituent being represented by Formula I or Formula II, wherein n is an integer from 2 to 20, and wherein m is an integer from 1 to 20.

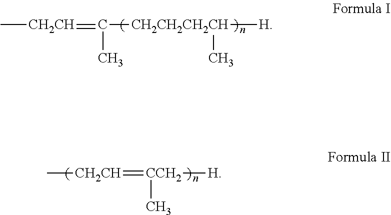

The light fastness additive of the electrophoretic medium may be a substituted 1,4-benzoquinone, the substituted 1,4-benzoquinone being represented by Formula III.

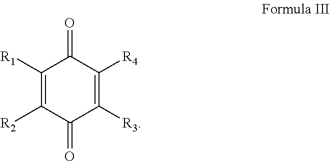

R₁ may be represented by Formula I or Formula II, wherein n may be an integer from 2 to 20 and m may be an integer from 1 to 20 or from 2 to 13. R₂ to R₄ may be independently selected from the group consisting of hydrogen, an alkyl group, an alkenyl group, an aryl group, and a heteroatomic group containing hetero atoms of Groups V-VII of the periodic table.

The light fastness additive of the electrophoretic medium may be represented by Formula III, wherein R₁ may be represented by Formula II with m being an integer from 2 to 20, and wherein each of R₂, R₃, and R₄ are independently selected from the group consisting of hydrogen, alkyl, alkenyl, and alkoxy groups.

The light fastness additive of the electrophoretic medium may be represented by Formula III, wherein R₁ may be represented by Formula II with m being an integer from 2 to 20, wherein R₂ may be methyl group, and wherein R₃, and R₄ may be methoxy groups.

The light fastness additive of the electrophoretic medium may be represented by Formula III, wherein R₁ may be represented by Formula II with m being an integer from 2 to 20, wherein R₂ may be hydrogen, and R₃, and R₄ may be methyl groups.

The light fastness additive may be a substituted 1,4-benzoquinone represented by Formula IV.

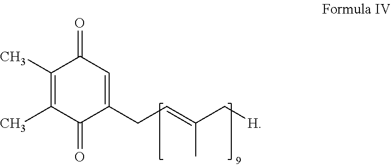

The light fastness additive may be a substituted 1,4-benzoquinone represented by Formula V (ubiquinone-10).

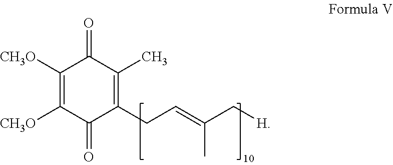

The light fastness additive of the electrophoretic medium may be a substituted 1,4-benzoquinone, the substituted 1,4-benzoquinone being represented by Formula VI. Each of R₅, R₆, and R₇ may be independently selected from the group consisting of hydrogen, alkyl, alkenyl, and alkoxy groups. In Formula VI, o is an integer from 2 to 20.

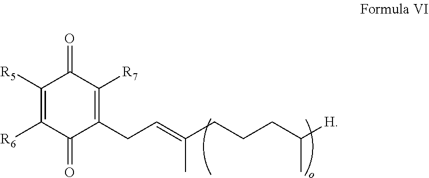

The light fastness additive of the electrophoretic medium may be a substituted naphthoquinone, the substituted naphthoquinone being represented by Formula VII. Each of R₈, R₉, R₁₀, R₁₁, and R₁₂ may be independently selected from the group consisting of hydrogen, alkyl, alkenyl, and alkoxy groups. In Formula VII, p is an integer from 2 to 20.

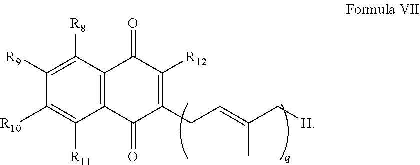

The light fastness additive of the electrophoretic medium may be a substituted naphthoquinone, the substituted naphthoquinone being represented by Formula VIII. Each of R₁₃, R₁₄, R₁₅, R₁₆, and R₁₇ may be independently selected from the group consisting of hydrogen, alkyl, alkenyl, and alkoxy groups. In Formula VIII, q is an integer from 2 to 20. Integer p of Formula VIII may be selected from the group consisting of 3, 4, 7, and 9.

In examples of a light fastness additive that is represented by Formula VIII, R₁₃, R₁₄, R₁₅, R₁₆, and R₁₇ may be hydrogens, and R₂₁ is methyl. Integer q of the examples may be 3, 4, 7, or 9.

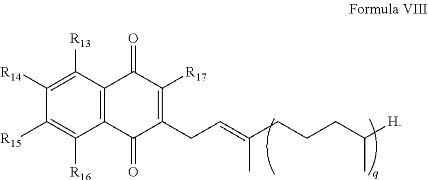

### BRIEF DESCRIPTION OF DRAWINGS

FIG. 1 is a side view of a color electro-optic display comprising electrophoretic medium encapsulated in microcapsules. The color electrophoretic display comprises, in order, a first electrode layer, an electro-optic material layer, a first adhesive layer, and a second electrode layer.

FIG. 2 is a side view of a color electro-optic display comprising electrophoretic medium encapsulated in microcapsules. The color electrophoretic display comprises, in order, a first electrode layer, a second adhesive layer, an electro-optic material layer, a first adhesive layer, and a second electrode layer.

FIG. 3 is a side view of a color electro-optic display comprising electrophoretic medium encapsulated in microcells. The color electrophoretic display comprises, in order, a first electrode layer, an electro-optic material layer including a sealing layer, a first adhesive layer, and a second electrode layer.

FIGS. 4, 5, and 6 are microphotographs of the microcapsules of the electro-optic material layer for three different electrophoretic media.

### DETAILED DESCRIPTION OF THE INVENTION

The term “electron acceptor”, or the synonymous term “electron acceptor molecule”, as used herein refers to a compound that accepts electrons from another molecule, the other molecule being an electron donor. That is, an electron acceptor may be an oxidizing agent.

The terms “substituted 1,2-benzoquinone”, “substituted 1,4-benzoquinone”, “substituted naphthoquinone”, and “substituted anthraquinone” are molecules the molecular structure of which comprise a 1,2-benzoquinone, 1,4-benzoquinone, a naphthoquinone, and an anthraquinone ring structure and at least one substituent, the at least one substituent being directly connected to the 1,2-benzoquinone, the 1,4-benzoquinone, the naphthoquinone, and the anthraquinone ring structure.

The term “alkyl group”, as used herein, means a hydrocarbon group that may be linear or branched. The hydrocarbon group comprises carbon-carbon single bonds. It does not comprise carbon-carbon double bonds or carbon-carbon triple bonds.

The term “cycloalkyl group”, as used herein, refers to a saturated hydrocarbon that contain ring structures. The saturated hydrocarbon may contain monocyclic, bicyclic, tricyclic, or other polycyclic hydrocarbon groups. The carbon atoms that are on the ring structure may include substituents, which may be linear or branched.

The term “alkenyl group”, as used herein, refers to a hydrocarbon group having at least one carbon-carbon double bond. The hydrocarbon group may be linear or branched.

The term “aryl group”, as used herein, is a hydrocarbon group that comprises an aromatic ring.

The term “heteroatomic group”, as used herein, refers to an alkyl, cycloalkyl, alkenyl, or aryl group that further contains, in addition to carbon atoms and hydrogen atoms, at least one hetero atom of the Groups V-VII of the periodic table.

The term “aliphatic hydrocarbon”, as used herein, includes both saturated and unsaturated, nonaromatic, linear (i.e. straight chain), branched, acyclic, and cyclic hydrocarbons.

A compound is “soluble” in a liquid, if at least 1 gram of the compound can be dissolved in 100 grams of the liquid.

The term “light fastness” referring to a color electro-optic display relates to the consistency of the color quality of the images of color electro-optic display over time. Reduction of the color quality of the images of the color electro-optic display over time means that the total color gamut that the color electro-optic display is able to provide is reduced.

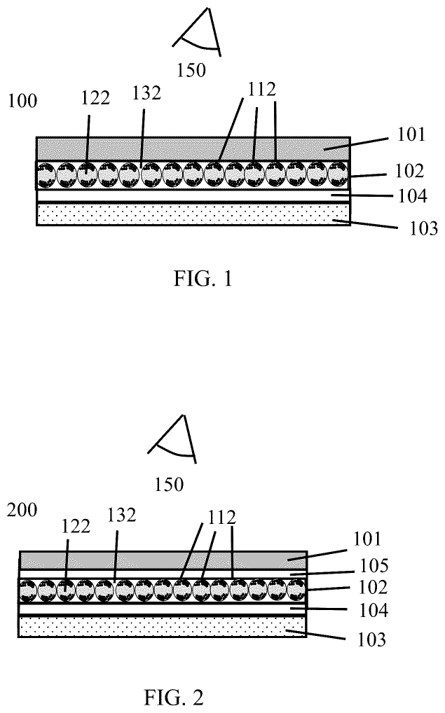

A typical color electro-optic display may have an electro-optic material layer that comprises an electrophoretic medium, which is encapsulated in microcapsules or microcells, as described in U.S. Pat. No. 6,982,178. FIG. 1 shows a side view of an example of the basic structure of a portion of a color electro-optic display having microcapsules. Color electro-optic display 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles in a non-polar liquid. Electrophoretic medium 122 comprises a plurality of first type of charged pigment particles and a plurality of second type of pigment particles. At least one of the first and second types of charged pigment particles comprises an organic pigment. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Electrophoretic medium 122 further comprises a light fastness additive. Typically, the plurality of microcapsules are retained within a polymeric binder 132. A viewer can view the image of display 100 from the viewing side 150. At least one type of charged pigment may comprise an organic pigment. The color electro-optic material layer 100 may be constructed from a front plane laminate, as described in the background of the invention.

Another example of a color electro-optic display is shown in FIG. 2. FIG. 2 illustrates a side view of an example of the basic structure of a portion of a color electro-optic display having microcapsules. Electro-optic display 200 has a viewing side 150. It comprises, in order, a first electrode layer 101 comprising a light transmissive electrode, a second adhesive layer 105, an electro-optic material layer 102, a first adhesive layer 104, and a second electrode layer 103, comprising a plurality of pixel electrodes. The second adhesive layer 105 connects first electrode layer 101 with electro-optic material layer 102. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles in a non-polar liquid. Electrophoretic medium 122 comprises a plurality of first type of charged pigment particles and a plurality of second type of pigment particles. At least one of the first and second types of charged pigment particles comprises an organic pigment. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Electrophoretic medium 122 further comprises a light fastness additive. Typically, the plurality of microcapsules are retained within a polymeric binder 132. The color electro-optic material layer 100 may be constructed from a double release sheet as described in the background of the invention.

The microcapsule color electro-optic displays of FIGS. 1 and 2 may further comprise a light transmissive front substrate (not shown in FIGS. 1 and 2), which is adjacent to the first electrode layer 101, wherein the electrode layer is disposed between the front substrate and the electro-optic material layer (for the display of FIG. 1) or between the front substrate and the second adhesive layer (for the display of FIG. 1). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

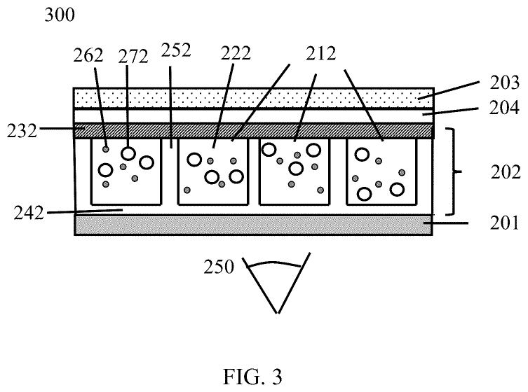

An example of a color electro-optic display that comprises microcells is illustrated in FIG. 3. Color electro-optic display 300 of FIG. 3 comprises, in order, a first electrode layer 201, an electro-optic material layer 202, an adhesive layer 204, and a second electrode layer 203, which comprises a plurality of pixel electrodes. Adhesive layer 204 connects sealing layer 232 of the electro-optic material layer 202 with second electrode layer 203 Electro-optic material layer 202 of color electro-optic display 300 comprises a plurality of microcells 212 and a sealing layer 232. Each microcell 212 of the plurality of microcells has a bottom 242, partition walls 252, and an opening, the sealing layer 232 spanning the opening of each microcell. Each microcell 212 of the plurality of microcells comprises electrophoretic medium 222. Electrophoretic medium 222 comprises a plurality of first type of charged pigment particles 272 and a plurality of second type of charged pigment particles 262 in a non-polar liquid. At least one of the first and second types of charged pigment particles (272 and 262) comprises an organic pigment. Electrophoretic medium 222 may further comprise a plurality of third type of charged pigment particles. Electrophoretic medium 222 may further comprise a plurality of fourth type of charged pigment particles. Electrophoretic medium 222 may further comprise a plurality of fifth type of charged pigment particles. Electrophoretic medium 222 further comprises a light fastness additive. A viewer can view the image of display 100 from the viewing side 250.

The microcell color electro-optic displays of FIG. 3 may further comprise a light transmissive front substrate (not shown in FIG. 3), which is adjacent to the first electrode layer 201, wherein the electrode layer is disposed between the front substrate and the electro-optic material layer. The front substrate may be a plastic film, such as a sheet of poly(ethylene terephthalate) (PET) having thickness of from 25 to 200 μm. Front substrate may further comprise one or more additional layers, for example, a protective layer to absorb ultra violet radiation, barrier layers to prevent ingress of oxygen or moisture into the display, and anti-reflection coatings to improve the optical properties of the display.

In the electro-optic displays of FIGS. 1, 2, and 3, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic display devices. Microcell arrays suitable for use with the invention can be created with micro-embossing.

The electrophoretic medium of the color electro-optic display of the present invention comprises charged pigment particles, a light fastness additive, and a non-polar liquid. The non-polar liquid may comprise an aliphatic hydrocarbon. The light fastness additive is an electron acceptor. The light fastness additive is present in the electrophoretic medium in a content of 0.1 weight percent to 6.0 weight percent by weight of the electrophoretic medium. The light fastness additive may be present in the electrophoretic medium in a content of 0.2 weight percent to 5.0 weight percent, in a content of 0.4 weight percent to 4.0 weight percent, in a content of 0.5 weight percent to 3.0 weight percent, in a content of 0.6 weight percent to 2.0 weight percent, or in a content of 0.7 weight percent to 1.5 weight percent by weight of the electrophoretic medium. The light fastness additive is soluble in the non-polar liquid of the electrophoretic medium. The light fastness additive is soluble in the electrophoretic medium.

The light fastness additive may be selected from the group consisting of a substituted 1,2-benzoquinone, a substituted 1,4-benzoquinone, a substituted naphthoquinone, and a substituted anthraquinone. The substituted 1,2-benzoquinone, the substituted 1,4-benzoquinone, the substituted naphthoquinone, and the substituted anthraquinone may have at least one substituent comprising an alkyl group, a cycloalkyl group, or an alkenyl group. The at least one substituent may have 8 or more carbon atoms, 10 or more carbon atoms, 12 or more carbon atoms, 15 or more carbon atoms, 20 or more carbon atoms, 25 or more carbon atoms, 30 or more carbon atoms, 35 or more carbon atoms, 40 or more carbon atoms, 60 or more carbon atoms, 80 or more carbon atoms, 100 or more carbon atoms, or 110 or more carbon atoms.

The at least one substituent may have from 8 to 120 carbon atoms, from 10 to 120 carbon atoms, from 12 to 110 carbon atoms, from 15 to 110 carbon atoms, from 20 to 110 carbon atoms, from 25 to 110 carbon atoms, from 30 to 110 carbon atoms, or from 40 to 110 carbon atoms. The at least one substituent may have from 8 to 105 carbon atoms, from 10 to 100 carbon atoms, from 12 to 90 carbon atoms, from 15 to 90 carbon atoms, from 20 to 85 carbon atoms, from 25 to 80 carbon atoms, from 30 to 85 carbon atoms, or from 40 to 85 carbon atoms.

The light fastness additive may be a substituted a 1,2-benzoquinone, a substituted 1,4-benzoquinone, a substituted naphthoquinone, and a substituted anthraquinone having at least one substituent, the at least one substituent being represented by Formula I or Formula II, wherein n is an integer from 2 to 20, and wherein m is an integer from 1 to 20.

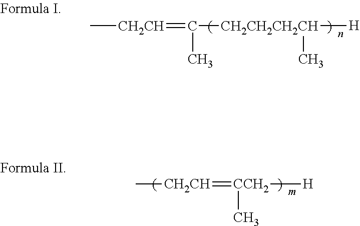

The light fastness additive may be a substituted 1,4-benzoquinone, the substituted 1,4-benzoquinone being represented by Formula III, wherein R₁ is represented by Formula I or Formula II, wherein n is an integer from 2 to 20 and m is an integer from 1 to 20. Integer n may be from 1 to 20, from 2 to 18, from 2 to 15, from 3 to 12, or from 3 to 10. Integer m may be from 1 to 20, from 1 to 18, from 2 to 18, from 2 to 15, from 3 to 15, from 3 to 12, from 3 to 10, or from 4 to 10. Substituent R₁ may also be an alkyl group comprising from 10 to 100 carbon atoms, from 10 to 80 carbon atoms, from 10 to 70 carbon atoms, from 10 to 50 carbon atoms, from 10 to 30 carbon atoms, from 10 to 20 carbon atoms, or from 10 to 15 carbon atoms. Substituents R₂ to R₄ may be independently selected from the group consisting of hydrogen, an alkyl group, an alkenyl group, an aryl group, and a heteroatomic group containing hetero atoms of Groups V-VII of the periodic table. The heteroatom may be selected from the group consisting of nitrogen, oxygen, halogen, phosphorus, or sulfur.

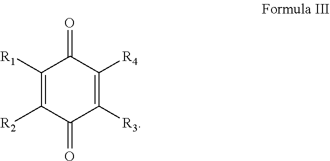

The light fastness additive may be a 1,4-benzoquinone represented by Formula III with substituent R₁ being represented by Formula II with integer m being from 2 to 20, and each of R₂, R₃, and R₄ being independently selected from the group consisting of hydrogen, alkyl, alkenyl, and alkoxy groups. The light fastness additive may be a 1,4-benzoquinone represented by Formula III with substituent R₁ being represented by Formula II with integer m being from 2 to 20, R₂ being hydrogen, and R₃ and R₄ being methyl groups.

The light fastness additive may be a 1,4-benzoquinone represented by Formula III with substituent R₁ being represented by Formula II with m being 9, R₂ being hydrogen, and R₃ and R₄ being methyl groups. The molecular structure of this light fastness additive is represented by Formula IV.

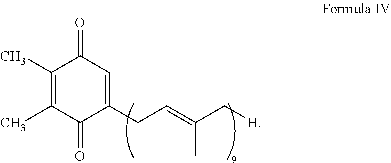

The light fastness additive may be a 1,4-benzoquinone represented by Formula III with substituent R₁ being represented by Formula II with m being 10, R₂ being methyl group, and R₃ and R₄ being methoxy groups. The molecular structure of this light fastness additive is represented by Formula V. Formula V is known in the literature as ubiquinone-10.

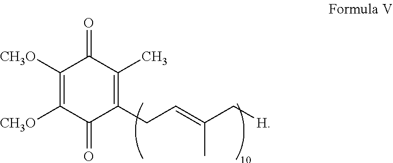

The light fastness additive may be a 1,4-benzoquinone represented by Formula III with substituent R₁ being represented by Formula II with m being 2, R₂ being methyl group, and R₃ and R₄ being methoxy groups.

The light fastness additive may be a 1,4-benzoquinone represented by Formula VI, wherein each of R₅, R₆, and R₇ may be independently selected from the group consisting of hydrogen, alkyl, alkenyl, and alkoxy groups, and wherein o is an integer from 2 to 20.

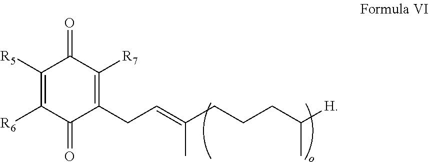

The light fastness additive may be a substituted naphthoquinone represented by Formula VII, wherein each of R₅, R₉, R₁₀, R₁₁, and R₁₂ may be independently selected from the group consisting of hydrogen, alkyl, alkenyl, and alkoxy groups, and wherein p is an integer from 2 to 20.

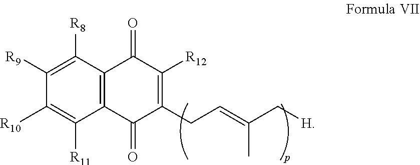

The light fastness additive may be a substituted naphthoquinone represented by Formula VIII, wherein each of R₁₃, R₁₄, R₁₅, R₁₆, and R₁₇ may be independently selected from the group consisting of hydrogen, alkyl, alkenyl, and alkoxy groups, and wherein q is an integer from 2 to 20.

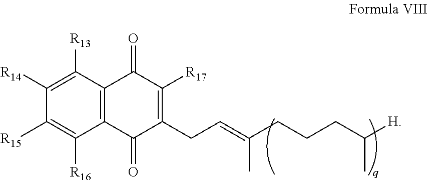

The light fastness additive may be a substituted naphthoquinone represented by Formula VIII, wherein q is an integer from 2 to 20, wherein R₁₃, R₁₄, R₁₅, R₁₆ are hydrogens, and R₁₇ is methyl. Integer q may be selected from the group consisting of 3, 4, 7, and 9.

The electrophoretic medium of the inventive color electro-optic display of the present invention comprises two or more types of charged pigment particles. The electrophoretic medium of the inventive color electro-optic display of the present invention comprises a plurality of a first type of charged pigment particles, and a plurality of a second type of pigment particles. The first type of charged pigment particles have different color from the second charged pigment particles. At least one of the first and second charged pigment particles comprises an organic pigment. The electrophoretic medium of the inventive color electro-optic display may further comprise a plurality of third type of charged pigment particles, which may have different color from the first and second charged pigment particles. The third charged pigment particles might comprise an organic pigment. The electrophoretic medium of the inventive color electro-optic display may further comprise a plurality of fourth type of charged pigment particles, which may have different color from the first, second, and third charged pigment particles. The third charged pigment particles might comprise an organic pigment. The electrophoretic medium of the inventive color electro-optic display may further comprise a plurality of fifth type of charged pigment particles, which may have different color from the first, second, third, and fourth charged pigment particles. The fifth charged pigment particles might comprise an organic pigment.

Each type of charged pigment particles of the electrophoretic medium may have a positive or negative charge. If the electrophoretic medium comprises two types of charged pigment particles, i.e. a first and second type of charged pigment particles, the first type of charged pigment particles may be negatively charged (or positively charged) and the second type of charged pigment particles may be positively charged (or negatively charged). Upon application of an electrical field across the electro-optic material layer via the light transmissive electrically conductive layer and a pixel electrode of backplane, the first type of charged pigment particles of the electrophoretic medium move towards the positive electrode and the second charged pigment particles move towards the negative electrode, so that an observer viewing the display from viewing side, sees the portion of the display that corresponds to the pixel electrode either first charge pigment particles or second charged pigment particles, depending upon whether the light transmissive electrically conductive layer is positive or negative relative to the pixel electrode.

In one example, the electrophoretic medium comprises three types of charged pigment particles, each type having a different color form the other types. Two of the three types of the charged pigment particles may have a positive charge and one type of charged pigment particles has a negative charge. At least one of the types of charged pigment particles comprises an organic pigment. Two of the types of charged pigment particles might comprise an organic pigment. The color of three types of charged pigment particles may be selected from the group consisting of white, black, yellow, red, blue, cyan, and magenta.

In another example, the electrophoretic medium comprises four types of charged pigment particles. Each type of the charged pigment particles may have a different color. Two of the types of charged pigment particles might have a positive charge, and two of the types of charged pigment particles may have a negative charge. Alternatively, three of the types of charged pigment particles may have a positive charge, and one type of charged pigment particles may have a negative charge. At least one of the types of charged pigment particles comprises an organic pigment. Two types of charged pigment particles may comprises an organic pigment. The color of four types of charged pigment particles may be selected from the group consisting of white, black, yellow, red, blue, cyan, and magenta. For example, the electrophoretic particles may comprise white, cyan, magenta, and yellow. Cyan, magenta, and yellow charged particles may have a positive charge and the white charged particles may have a negative charge.

In another example, the electrophoretic medium comprises five types of charged pigment particles. Each type of the charged pigment particles may have a different color. Three of the types of charged pigment particles might have a positive charge, and two of the types of charged pigment particles may have a negative charge. Alternatively, four of the types of charged pigment particles may have a positive charge, and one type of charged pigment particles may have a negative charge. At least one of the types of charged pigment particles comprises an organic pigment. Two, three, or four types of charged pigment particles may comprises an organic pigment. The color of five types of charged pigment particles may be selected from the group consisting of white, black, green, yellow, red, blue, cyan, green, and magenta. For example, the electrophoretic particles may comprise white, cyan, magenta, and yellow. Cyan, magenta, and yellow charged pigment particles may have a positive charge and the white charged particles may have a negative charge.

As mentioned above, organic pigments have, typically, lower long term color stability than inorganic pigments. However, in terms of color, organic pigments are much more desirable, because they exhibit much more bright and chromatic colors than inorganic pigments. That is, the color of organic pigments is less robust over time, upon exposure to ultraviolet light or visible light. The light fastness additive of the color electrophoretic medium of the inventive color electro-optic display significantly improved the light fastness of the inventive electro-optic display.

Although the mechanism of the reduction of the color quality of the images of a color electro-optic display over long term exposure to light is not fully understood, the inventors of the present invention observed that the light fastness of a color electro-optic display was reduced by the addition of electron donor molecules, such as amines, into the electrophoretic medium composition. It is likely that there may be uncontrolled trace amounts of electron donor molecules in the materials used to make an electrophoretic composition. For example, a charge control agent (CCA), which is a surfactant-type molecules that is commonly a quaternary ammonium salt, is prepared by reacting an amine with an appropriate alkylating agent. Incomplete alkylation would result in the presence of some free amine, which, as noted above, is an electron donor. Since alkylating agents are toxic compounds, manufacturers of quaternary salts commonly slightly under-add them for safety reasons. The result in that many commercially available or custom CCA molecules contain small amounts of free amine.

An example of an electron donor is ubiquinol-10, which is the fully reduced form of ubiquinone-10 (Formula V shown above). The inventors of the present invention found that addition of ubiquinol-10 (electron donor molecule) in the electrophoretic medium of a color electro-optic display has a detrimental effect on the light fastness of a color electro-optic display. On the contrary, the inventors of the present invention found that electron acceptor molecules, such as ubiquinone-10, have a beneficial effect on the light fastness of a color electro-optic display. An example of an electron acceptor that was evaluated for light fastness additive is Ubiquinone-10 (also called Coenzyme Q10). This material is a readily available electron acceptor that is lipid soluble. Other quinone molecules that are electron acceptors and lipid-soluble (or soluble in a micelle core) are expected to exhibit similar behavior. Without being bound to any particular theory, it is possible that electrons are photo exited by the absorption of light. To prevent those excited electrons to negatively affect the light fastness of the electro-optic display, adding an electron acceptor into the electrophoretic medium possibly mitigates the detrimental effect of a potentially present electron donor, because the electron transfer takes place from the electron donor or photo-excited pigment molecule to the electron acceptor, rather than from the electron donor or photo-excited pigment molecule to pigment molecules.

### Examples

### I. Preparation of Pigment Particles and Dispersions in Isopar E.

Example 1A: White pigment particles were prepared with a titanium dioxide pigment core, which comprises a polymer coating, as described in Example 1 of U.S. Pat. No. 8,582,196. The polymer coating comprising an approximately 99:1 ratio of lauryl methacrylate (LMA) and 2,2,2-trifluoroethyl methacrylate (TFEM). After the polymerization reaction, the solvent was exchanged from toluene to Isopar E by repeated washes and removal of the supernatant liquid.

Example 1B: White pigment particles were prepared with a titanium dioxide pigment core, which comprises a polymer coating. The polymer coating is formed by polymerization of lauryl methacrylate (LMA), 2,2,2-trifluoroethyl methacrylate (TFEM), and polysiloxane macromonomer (PDMS). After the polymerization reaction, the solvent was exchanged from toluene to Isopar E by repeated washes and removal of the supernatant liquid.

Example 2A: Yellow pigment particles were prepared with C.I. Pigment Yellow 155 core, which comprises a polymer coating. The polymer coating was formed by polymerization of methyl methacrylate (MMA), 2,2,2-trifluoroethyl methacrylate (TFEM), and polysiloxane macromonomer (PDMS). After the polymerization reaction, the solvent was exchanged from toluene to Isopar E by repeated washes and removal of the supernatant liquid.

Example 2B: A dispersion was prepared by milling commercial Pigment Yellow 155 particles as generally described in Example 2 Part A of U.S. Pat. No. 9,697,778, using Solsperse 19,000 in Isopar E as medium.

Example 3A: Magenta pigment particles were prepared with magenta dimethylquinacridone pigment (C.I. Pigment Red 122), which comprises a polymer coating. The polymer coating was formed using vinylbenzyl chloride (VBC) and lauryl methyl methacrylate (LMA), as described in Example 1 of U.S. Pat. No. 9,697,778. After the polymerization reaction, the solvent was exchanged from toluene to Isopar E by repeated washes and removal of the supernatant liquid.

Example 4A: Cyan pigment particles were prepared with cyan copper phthalocyanine pigment (C.I. Pigment Blue 15:3), which comprises a polymer coating. The polymer coating was formed using methyl methacrylate monomer (MMA) and polysiloxane macromonomer (PDMS), as described in Example 7 of U.S. Pat. No. 10,509,293.

### II. Preparation of Electrophoretic Medium.

Example 5A: A dispersion containing white pigment from Example 1A was combined with a dispersion containing the yellow pigment from Example 2A, a dispersion containing the magenta pigment from Example 3A, a dispersion containing the cyan pigment from Example 4A, charge control agent CCA-111, ubiquinone-10, Isopar E, and polyisobutylene (number average molecular weight 850,000). The structure and preparation of CCA-111 was described in United States Application with Publication No. 2020/0355978. The content of ubiquinone-10 in the electrophoretic medium of Example 5 was 3.0 weight percent by weight of the electrophoretic medium.

Comparative Example 6A: An electrophoretic medium was prepared similar to Example 5A, but without any light fastness additive ubiquinone-10. That is, Comparative Example 6A is a control electrophoretic medium. The measured conductivity of the electrophoretic medium was 430 pS/cm.

Example 7A: A dispersion containing white pigment from Example 1B was combined with a dispersion containing the yellow pigment from Example 2B, a dispersion containing the magenta pigment from Example 3A, a dispersion containing the cyan pigment from Example 4A, Solsperse 19,000, ubiquinone-10, Isopar E, and polyisobutylene (number average molecular weight 850,000). The content of ubiquinone-10 in the electrophoretic medium of Example 5 was 3.0 weight percent by weight of the electrophoretic medium. The conductivity of the electrophoretic medium was 417 pS/cm.

Comparative Example 8A: A dispersion similar to the electrophoretic medium of Example 7A was prepared with the difference that ubiquinone-10 was replaced by ubiquinol-10. Ubiquinol-10 is the reduced form of ubiquinone-10. Ubiquinol-10 is not an electron acceptor, but an electron donor. The conductivity of the electrophoretic medium was 449 pS/cm.

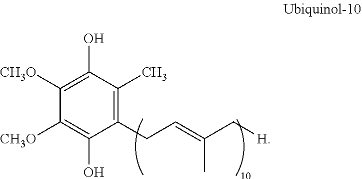

Comparative Example 9A: An electrophoretic medium was prepared similar to Example 7A and Comparative Example 8A, which does not contain ubiquinone-10 or ubiquinol-10. That is, Comparative Example 9A is a control electrophoretic medium.

### III. Encapsulation of the Electrophoretic Media.

Example 5B: The electrophoretic medium from Example 5A, was encapsulated in a gelatin/acacia coacervate using the following method. Gelatin is dissolved in deionized water at a temperature of 40° C., and vigorously stirred. The electrophoretic medium from Example 1 was added dropwise to the stirred gelatin solution through a tube the outlet of which is below the surface of the stirred solution. The resultant mixture was held at 42.5° C. with continued vigorous stirring to produce droplets of the electrophoretic medium in a continuous gelatin-containing aqueous phase. A solution of acacia in water at 42.5° C. was then added to the mixture, and the pH of the mixture is lowered to approximately 5 to cause formation of the gelatin/acacia coacervate, thereby forming microcapsules. The temperature of the resultant mixture is then lowered to 9° C. and an aqueous solution of glutaraldehyde (cross-linking agent) was added. The resultant mixture was then warmed to 25° C. and stirred vigorously for 12 hours. The microcapsules produced were separated by sieving, using sieves of 20 micrometers and 45 micrometers mesh size, to obtain microcapsules with a mean diameter of about 44 micrometers.

Comparative Example 6B: The process of encapsulation described in Example 5B was repeated for the encapsulation of the electrophoretic medium prepared from Comparative Example 6A.

Comparative Example 7B: The process of encapsulation described in Example 5B was repeated for the encapsulation of the electrophoretic medium prepared from Comparative Example 7A.

Comparative Example 8B: The process of encapsulation described in Example 5B was repeated for the encapsulation of the electrophoretic medium prepared from Comparative Example 8A.

Comparative Example 9B: The process of encapsulation described in Example 5B was repeated for the encapsulation of the electrophoretic medium prepared from Comparative Example 9A.

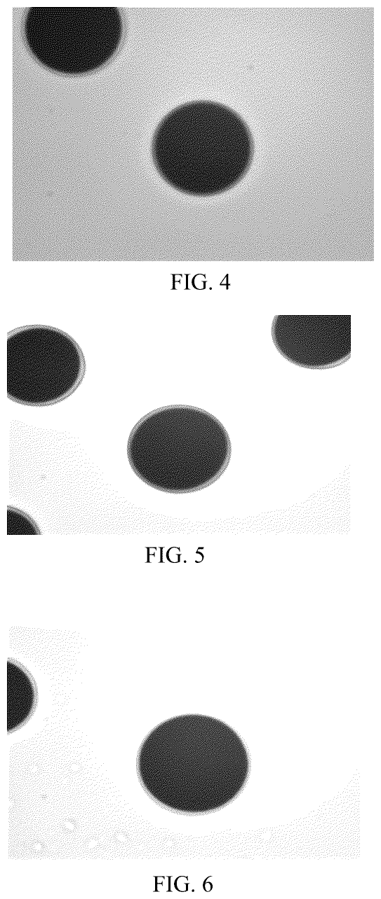

Samples of the microcapsules from Example 7B, Comparative Example 8B, and Comparative Example 9B were observed using a microscope. The microscopic images are shown in FIGS. 4, 5, and 6 respectively. The images of the microcapsules of all three examples are similar and there is no indication of microcapsule aggregation. This indicates that the presence of ubiquinone-10 does not affect the quality of the microcapsules.

### IV. Preparation of Microcapsule Slurries

Example 5C1: The sieved microcapsule solution prepared in Example 5B was adjusted to pH of 9 and the microcapsules allowed to settle by gravity or through centrifugation. After settling, the excess water was removed. A solution of poly(vinyl alcohol) (19% in water) binder was added into the concentrated capsule dispersion at a concentration of 60 milligrams per gram of microcapsules. The resulting slurry was mixed overnight.

Comparative Example 6C1: The process of preparation of microcapsule slurry of Example 5C was repeated using the sieved microcapsule solution prepared in Comparative Example 6B.

Example 7C1: The process of preparation of microcapsule slurry of Example 5C was repeated using the sieved microcapsule solution prepared in Example 7B.

Comparative Example 8C1: The process of preparation of microcapsule slurry of Example 5C was repeated using the sieved microcapsule solution prepared in Comparative Example 5B.

Comparative Example 9C1: The process of preparation of microcapsule slurry of Example 5C was repeated using the sieved microcapsule solution prepared in Comparative Example 9B.

Example 5C2: The process of preparation of microcapsule slurry of Example 5C1 was repeated, but the poly(vinyl alcohol) solution was replaced by a polyurethane dispersion.

Example 6C2: The process of preparation of microcapsule slurry of Example 6C1 was repeated, but the poly(vinyl alcohol) solution was replaced by a polyurethane dispersion.

### V. Preparation Color Electro-Optic Displays

Example 5D: The slurry that was prepared in Example 5C1 was bar coated onto a 127 micrometer thick polyester film coated with indium tin oxide (ITO), which acts as a first electrode layer. The coated film was oven dried to produce a film having a thickness of approximately 30 micrometers. The film contained essentially a single layer of microcapsules on ITO. From the resulting film, a front plane laminate (see U.S. Pat. No. 6,982,178) was produced by laminating a polyurethane adhesive over the capsule layer. The front plane laminate was then laminated to a segmented graphite backplane comprising a layer of graphite on a polyester film to produce a color electro-optic display that is suitable for measurement of their electro-optical properties. The color electro-optic display was equilibrated for five days at a temperature of 25° C. and a relative humidity of 50%.

Comparative Example 6D: The process of preparing the electro-optic display of Example 5D was repeated using the slurry from Comparative Example 6C1.

Example 7D: The process of preparing the electro-optic display of Example 5D was repeated using the slurry from Example 7C1.

Comparative Example 8D: The process of preparing the electro-optic display of Example 5D was repeated using the slurry from Comparative Example 8C1.

Comparative Example 9D: The process of preparing the electro-optic display of Example 5D was repeated using the slurry from Comparative Example 9C1.

Example 5E: The process of preparing the electro-optic display of Example 5D was repeated using the slurry from Example 5C2.

Comparative Example 6E: The process of preparing the electro-optic display of Example 5D was repeated using the slurry from Comparative Example 6C2.

### VI. Light Fastness Evaluation of Color Electro-Optic Displays.

The light fastness of the color electro-optic displays from Example 5D, Comparative Example 6D, Example 7D, Comparative Example 8D, Comparative Example 9D, Example 5E, and Comparative Example 6E were evaluated by irradiating half of each display, while keeping the other half covered from light. The covered half was used as control for the exposed portion of the display. The experiment was carried out in a temperature-humidity controlled environment. The evaluation involved the steps (a) placement of the display inside a chamber with a relative humidity of approximately 50% and a temperature of about 25° C., and (b) irradiating half of the display using a D65 (6500K) CIE, which corresponds roughly to the average midday light in Western Europe/Northern Europe (comprising both direct sunlight and the light diffused by a clear sky), hence it is called a daylight illuminant.

The color gamut of each color electro-optic display was measured following the Electro-optical testing procedure described in the next section. An arbitrary assessment of light fastness of the displays was calculated by comparing the percentage color gamut loss between the exposed and non-exposed area normalized to the exposed value. Panels with less % gamut loss were considered to have higher light fastness.

### VII. Method of Evaluation of Electro-Optical Performance.

The electro-optic displays from Example 5D, Comparative Example 6D, Example 5E, Comparative Example 6E, Example 7D, Comparative Example 8D, and Comparative Example 9D were electrically driven to generate eight optical states. The electrophoretic devices were addressed using sequences of electrical pulses (such sequences being referred to as a “waveform”). In the following description, the voltages used in the waveform are those supplied to the rear electrodes of the display, assuming that the electrode at the front (viewing) surface of the display is a first electrode to all pixels and is connected to ground. The color state of the display (measured in CIELab L*, a* and b* units) was recorded. The color gamut of each display was measured by computing the volume of the convex hull containing every colored state produced by the set of testing waveforms. Type I electrophoretic medium corresponds to Example 5A, and Comparative Example 6A. Type II electrophoretic medium corresponds to Example 7A, Comparative Example 8A, and Comparative Example 9A. The results of the evaluation of electro-optical performance are summarized in Table 1.

TABLE 1
Evaluation of Electro-Optic Performance

| | | | | Light Fastness |
|---|---|---|---|---|
| Electro- | Electro- | | | Additive Content |
| Optic | phoretic | | Light Fastness | in Electrophoretic |
| Display | Medium | Binder | Additive | Medium weight % |
| Ex. 5D | Type I | Type I | Ubiquinone-10 | 1.8 |
| | | (PVOH) | | |
| Comparative | Type I | Type I | None | 0.0 |
| Ex. 6D | | (PVOH) | | |
| Ex. 5E | Type I | Type II | Ubiquinone-10 | 1.8 |
| | | (PU) | | |
| Comparative | Type I | Type II | None | 0.0 |
| Ex. 6E | | (PU) | | |
| Ex. 7D | Type II | Type I | Ubiquinone-10 | 1.0 |
| | | (PVOH) | | |
| Comparative | Type II | Type I | None | 0.0 (Ubiquinol- |
| Ex. 8D | | (PVOH) | (ubiquinol-10 is | 10 content |
| | | | present) | at 1.0%) |
| Comparative | Type II | Type I | None | 0.0 |
| Ex. 9D | | (PVOH) | | |

| | Unexposed | Exposed | Percent Color Gamut |
|---|---|---|---|
| Electro-Optic | Color Gamut | Color Gamut | Lost from Light |
| Display | (DE³) | (DE³) | Exposure (DE³) |
| Ex. 5D | 79,227 | 72,212 | 9 |
| Comparative Ex. 6D | 116,162 | 54,598 | 53 |
| Ex. 5E | 52,050 | 43,208 | 17 |
| Comparative Ex. 6E | 60,160 | 19,023 | 68 |
| Ex. 7D | 89,086 | 80,653 | 9 |
| Comparative Ex. 8D | 104,210 | 34,536 | 67 |
| Comparative Ex. 9D | 112,270 | 45,363 | 60 |

The results clearly show that incorporation of the electron acceptor ubiquinone-10 in the electrophoretic medium reduced the amount of color gamut loss induced by exposure to light, expressed in percent color gamut lost in Table 1. In addition, Table 1 showed that addition of the electron donor ubiquinol-10 (reduced form of ubiquinone-10) into the electrophoretic medium has a detrimental effect in the light fastness of the color electro-optic display. The beneficial effect of the electron acceptor is observed for electrophoretic displays of two different types (Type I and Type II) and also for two different types of binders (polyvinyl alcohol and polyurethane).

What is claimed is:

1. A color electro-optic display comprising, in order:
a first electrode layer comprising a light-transmissive electrode;
an electro-optic material layer comprising an electrophoretic medium, the electrophoretic medium being encapsulated in a plurality of microcell or microcapsules, the electrophoretic medium comprising a plurality of first type of charged pigment particles, a plurality of second type of charged pigment particles, a light fastness additive, and a non-polar liquid, the light fastness additive being an electron acceptor and is present in the electrophoretic medium in a content of 0.1 weight percent to 6.0 weight percent by weight of the electrophoretic medium;
a second electrode layer comprising a plurality of pixel electrodes.

2. The color electro-optic display of claim 1, wherein the light fastness additive is selected from the group consisting of a substituted 1,4-benzoquinone, a substituted 1,2-benzoquinone, a substituted naphthoquinone, and a substituted anthraquinone, wherein the substituted 1,4-benzoquinone, the substituted 1,2-benzoquinone, the substituted naphthoquinone, and the substituted anthraquinone have at least one substituent comprising an alkyl group, a cycloalkyl group, or alkenyl group, and wherein the at least one substituent has from 10 to 120 carbon atoms.

3. The color electro-optic display of claim 2, wherein the substituted 1,2-benzoquinone, the substituted 1,4-benzoquinone, the substituted naphthoquinone, and the substituted anthraquinone have at least one substituent, the at least one substituent being represented by Formula I or Formula II, wherein n is an integer from 2 to 20, and wherein m is an integer from 1 to 20.

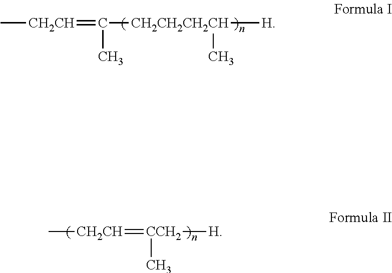

4. The color electro-optic display of claim 2, wherein the light fastness additive is a substituted 1,4-benzoquinone is represented by Formula III, 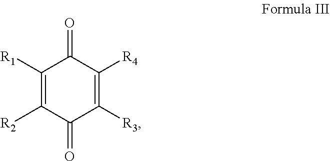
wherein R₁ is represented by Formula I or Formula II, wherein n is an integer from 2 to 20 and m is an integer from 1 to 20, and wherein R₂ to R₄ are independently selected from the group consisting of hydrogen, an alkyl group, an alkenyl group, an aryl group, and a heteroatomic group containing hetero atoms of Groups V-VII of the periodic table.

5. The color electro-optic display of claim 4, wherein R₁ is represented by Formula II with m being an integer from 2 to 20, and wherein each of R₂, R₃, and R₄ are independently selected from the group consisting of hydrogen, alkyl, alkenyl, and alkoxy groups.

6. The color electro-optic display of claim 5, wherein R₂ is methyl group, and wherein R₃ and R₄ are methoxy groups.

7. The color electro-optic display of claim 5, wherein R₂ is hydrogen, and wherein R₃ and R₄ are methyl groups.

8. The color electro-optic display of claim 7, wherein the light fastness additive is represented by Formula IV or Formula V.

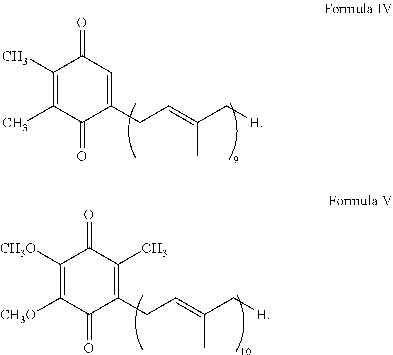

9. The color electro-optic display of claim 2, wherein the molecular structure of the light fastness additive is a substituted benzoquinone, which is represented by Formula VI, 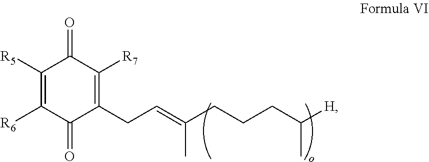
wherein each of R₅, R₆, and R₇ may be independently selected from the group consisting of hydrogen, alkyl, alkenyl, and alkoxy groups, and wherein o is an integer from 2 to 20.

10. The color electro-optic display of claim 2, wherein the light fastness additive is a substituted naphthoquinone, the substituted naphthoquinone being represented by Formula VII, 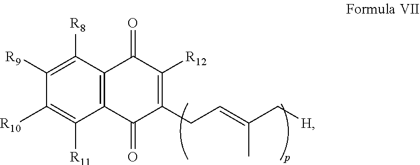
wherein each of R₈, R₉, R₁₀, R₁₁, and R₁₂ may be independently selected from the group consisting of hydrogen, alkyl, alkenyl, and alkoxy groups, and wherein p is an integer from 2 to 20.

11. The color electro-optic display of claim 2, wherein the light fastness additive is a substituted naphthoquinone, the substituted naphthoquinone being represented by Formula VIII, 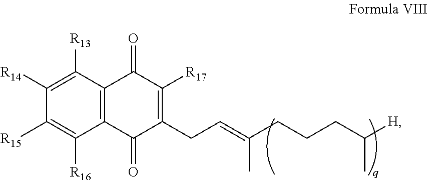
wherein each of R₁₃, R₁₄, R₁₅, R₁₆, and R₁₇ may be independently selected from the group consisting of hydrogen, alkyl, alkenyl, and alkoxy groups, and wherein q is an integer from 2 to 20.

12. The color electro-optic display of claim 11, wherein the molecular structure of the light fastness additive is represented by Formula VIII, wherein R₁₃, R₁₄, R₁₅, R₁₆ are hydrogens, and R₁₇ is methyl.

13. The color electro-optic display of claim 12, wherein q is selected from the group consisting of 3, 4, 7, and 9.

14. The color electro-optic display of claim 1, wherein the electrophoretic medium further comprises a plurality of third type of charged pigment particles and a plurality of fourth type of charged pigment particles.

15. The color electro-optic display of claim 14, wherein the first, second, third, and fourth types of charged pigment particles have a color selected from the group consisting of white, black, cyan, magenta, yellow, blue, green, and red.

16. The color electro-optic display of claim 14, wherein the first, second, third, and fourth types of charged pigment particles are white, cyan, magenta, and yellow respectively.

17. The color electro-optic display of claim 1, wherein the electro-optic material layer comprises the plurality of microcapsules and a binder.

18. The color electro-optic display of claim 17, wherein the color electro-optic display further comprises a first adhesive layer, the first adhesive layer being disposed between the electro-optic material layer and the second electrode layer.

19. The color electro-optic display of claim 18, wherein the color electro-optic display further comprises a second adhesive layer, the second adhesive layer being disposed between the electro-optic material layer and the first electrode layer.

20. The color electro-optic display of claim 1, wherein the electro-optic material layer comprises the plurality of microcells, each microcell of the plurality of microcells having a microcell bottom, partition walls, an opening, and a sealing layer spanning the opening, the sealing layer being adjacent to the second electrode layer.
